(19) United States
(12) Patent Application Publication
(10) Pub. No.: US 2024/0406621 A1
(43) Pub. Date: Dec. 5, 2024

(54) DISTRIBUTED TELECONFERENCING USING ADAPTIVE MICROPHONE SELECTION

(71) Applicant: Microsoft Technology Licensing, LLC, Redmond, WA (US)

(72) Inventors: Ross G. CUTLER, Clyde Hill, WA (US); Hong Wang SODOMA, Redmond, WA (US); Robert Andreas AICHNER, Bellevue, WA (US); Vinod PRAKASH, Redmond, WA (US); Warren Michael LAM, Bellevue, WA (US)

(73) Assignee: Microsoft Technology Licensing, LLC, Redmond, WA (US)

(21) Appl. No.: 18/204,245

(22) Filed: May 31, 2023

(51) Int. Cl. H04R 3/00; G10L 17/02; G10L 17/18; G10L 25/60; H04M 3/56; H04R 1/40; H04R 29/00

(52) U.S. Cl. CPC H04R 3/005; G10L 17/02; G10L 17/18; G10L 25/60; H04M 3/568; H04R 1/406; H04R 29/005; H04R 2410/01; H04R 2430/01

(57) ABSTRACT

This document relates to distributed devices teleconferencing. Some implementations can employ adaptive microphone selection based on signal characteristics such as signal-to-noise ratios or speech quality, and/or based on a microphone affinity approach. The selected microphone signals can be synchronized and mixed to generate a playback signal that is sent to a remote device. Further implementations can perform proximity-based mixing, where microphone signals received from devices in a particular room can be omitted from playback signals transmitted to other devices in the same room. These techniques can allow enhanced call quality for teleconferencing sessions where co-located users can employ their own devices to participate in a call with other users.

### BACKGROUND

One important use case for computing devices involves teleconferencing, where participants communicate with remote users via audio and/or video over a network. Often, audio signals for a given teleconference can include impairments such as device distortion, echoes, and/or noise. In some cases, audio enhancement to remove impairments can be performed by a centralized or distributed model, but there are various drawbacks to these approaches that are described in more detail below.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The description generally relates to techniques for distributed teleconferencing. One example includes a method or technique that can be performed on a computing device. The method or technique can include receiving multiple microphone signals from multiple co-located devices having respective microphones. The method or technique can also include selecting a microphone subset from the respective microphones based at least on respective signal characteristics of the multiple microphone signals. The method or technique can also include obtaining a playback signal from one or more microphone signals output by the selected microphone subset, and sending the playback signal to a remote device that is participating in a call with the multiple co-located devices.

Another example includes a system having a hardware processing unit and a storage resource storing computer-readable instructions. When executed by the hardware processing unit, the computer-readable instructions can cause the system to receive multiple microphone signals from multiple co-located devices having respective microphones. The computer-readable instructions can also cause the system to select a microphone subset from the respective microphones based at least on respective signal characteristics of the multiple microphone signals. The computer-readable instructions can also cause the system to obtain a playback signal from one or more microphone signals output by the selected microphone subset and send the playback signal to a remote device that is participating in a call with the multiple co-located devices.

Another example includes a computer-readable storage medium storing executable instructions. When executed by a processor, the executable instructions can cause a processor to perform acts. The acts can include receiving multiple microphone signals from multiple co-located devices having respective microphones. The acts can also include selecting a microphone subset comprising two or more of the respective microphones based at least on respective signal characteristics of the multiple microphone signals. The acts can also include producing a playback signal by synchronizing and mixing two more microphone signals output by the two or more respective microphones of the selected microphone subset, and sending the playback signal to a third device that is participating in a call with the multiple co-located devices.

The above listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 illustrates an example system, consistent with some implementations of the present concepts.

FIG. 2A-2C illustrate example teleconferencing scenarios with a single speaker, consistent with some implementations of the present concepts.

FIG. 3A-3D illustrate example teleconferencing scenarios with multiple speakers, consistent with some implementations of the present concepts.

FIG. 4 illustrates an example teleconferencing architecture, consistent with some implementations of the present concepts.

FIG. 5 illustrates an example method or technique for adaptive microphone selection, consistent with some implementations of the disclosed techniques.

### DETAILED DESCRIPTION

### Overview

The disclosed implementations generally offer techniques for enabling high-quality audio for teleconferences, including scenarios where co-located users employ personal devices to participate in a teleconference. As noted previously, conventional teleconferencing solutions often employ enhancement models to remove unwanted impairments such as echoes and/or noise from audio signals during a call. However, the use of enhancement models can have certain drawbacks.

One approach involves the use of a centralized enhancement model that enhances signals received from multiple microphones. However, effective employment of such centralized enhancement models often involves very precise synchronization of microphones and/or loudspeakers involved in the call. This can be very difficult due to issues such as network latency and jitter.

One way to reduce the synchronization difficulties for a centralized enhancement model is to employ an approach where co-located users share a single device. For instance, some offices have dedicated conference rooms with a single teleconferencing device having a microphone and loudspeaker that are shared by all users in the room. This approach reduces the complexity of synchronizing devices on the call relative to having each user employ their own personal device, since fewer microphones and loudspeakers need to be synchronized to accommodate the multiple users in the room.

However, dedicated teleconferencing rooms have their own drawbacks. For instance, users may wish to conduct ad-hoc meetings from arbitrary locations instead of having to schedule a dedicated teleconferencing room to conduct an online meeting. Users may also wish to employ their own personal devices to participate in the call, instead of having all users in a given room share the same device.

One potential approach for allowing ad-hoc teleconferencing in a shared space e involves employing distributed, personalized enhancement models on each device in the room. This approach has a lower network burden than centralized approaches and does not necessarily involve the use of dedicated teleconferencing rooms or devices. However, personalized enhancement models often require users to perform relatively burdensome enrollment steps in order to personalize a model for each user. Thus, in many cases, personalized enhancement models are not available for all parties to a distributed teleconference.

The disclosed implementations can overcome these deficiencies of prior techniques by employing adaptive microphone selection. Instead of mixing and playing back all the microphone signals for microphones in a given room, a subset of microphones can be selected based on signal characteristics of the microphone signals. By reducing the number of microphones that contribute to the resulting playback signal, the impact of impairments on the resulting playback signal can be mitigated, thus improving call quality without necessarily employing personalized enhancement models on each device in the room.

### Definitions

For the purposes of this document, the term “signal” refers to a function that varies over time or space. A signal can be represented digitally using data samples, such as audio samples, video samples, or one or more pixels of an image. An “enhancement model” refers to a model that processes data samples from an input signal to enhance the perceived quality of the signal. For instance, an enhancement model could remove noise or echoes from audio data, or could sharpen image or video data. The term “personalized enhancement model” refers to an enhancement model that has been adapted to enhance data samples specifically for a given user. For instance, as discussed more below, a personalized data enhancement model could be adapted to filter out noise, echoes, etc., to isolate particular user's voice by attenuating components of an audio signal produced by other sound sources.

The term “mixing,” as used herein, refers to combining two or more signals to produce another signal. Mixing can include adding two audio signals together to create linear or non-linear combinations of the audio signals, interleaving individual audio signals in different time slices, etc. In some cases, audio signals from two co-located devices can be mixed to obtain a playback signal. The term “synchronizing” means aligning two or more signals, e.g., prior to mixing. For instance, two or more microphone signals can be synchronized by identifying corresponding frames in the respective signals and temporally aligning those frames. Likewise, loudspeakers can also be synchronized by identifying and temporally aligning corresponding frames in sounds played back by the loudspeakers. In addition, audio signals can be synchronized with video signals.

The term “co-located,” as used herein, means that two devices have been determined to be within proximity to one another according to some criteria, e.g., the devices are within the same room, within a threshold distance of one another, etc. The term “playback signal,” as used herein, refers to a signal that can be played back by a loudspeaker and/or display. A playback signal can be a combination of one or more microphone signals and/or video signals. An “enhanced” signal is a signal that has been processed using an enhancement model to improve some signal characteristic of the signal.

The term “signal characteristic” describes how a signal can be perceived by a user, e.g., the overall quality of the signal or a specific aspect of the signal such as how noisy an audio signal is, how blurry an image signal is, etc. The term “quality estimation model” refers to a model that evaluates an input signal to estimate how a human might rate the perceived quality of the input signal for one or more signal characteristics. For example, a first quality estimation model could estimate the speech quality of an audio signal and a second quality estimation model could estimate the overall quality and/or background noise of the same audio signal. Audio quality estimation models can be used to estimate signal characteristics of an unprocessed or raw audio signal or a processed audio signal that has been output by a particular data enhancement model. The output of a quality estimation model can be a synthetic label representing the signal quality of a particular signal characteristic. Here, the term “synthetic label” means a label generated by a machine evaluation of a signal, where a “manual” label is provided by human evaluation of a signal.

The term “model” is used generally herein to refer to a range of processing techniques, and includes models trained using machine learning as well as hand-coded (e.g., heuristic-based) models. For instance, a machine-learning model could be a neural network, a support vector machine, a decision tree, etc. Whether machine-trained or not, data enhancement models can be configured to enhance or otherwise manipulate signals to produce processed signals. Data enhancement models can include codecs or other compression mechanisms, audio noise suppressors, echo removers, distortion removers, image/video healers, low light enhancers, image/video sharpeners, image/video denoisers, etc., as discussed more below.

The term “impairment,” as used herein, refers to any characteristic of a signal that reduces the perceived quality of that signal. Thus, for instance, an impairment can include noise or echoes that occur when recording an audio signal, or blur or low-light conditions for images or video. One type of impairment is an artifact, which can be introduced by a data enhancement model, such as a speech enhancement model, when removing impairments from a given signal. Viewed from one perspective, an artifact can be an impairment that is introduced by processing an input signal to remove other impairments. Another type of impairment is a recording device impairment introduced into a raw input signal by a recording device such a microphone or camera. Another type of impairment is a capture condition impairment introduced by conditions under which a raw input signal is captured, e.g., room reverberation for audio, low light conditions for image/video, etc.

The following discussion also mentions audio devices such as microphones and loudspeakers. Note that a microphone that provides a microphone signal to a computing device can be an integrated component of that device (e.g., included in a device housing) or can be an external microphone in wired or wireless communication with that computing device. Similarly, when a computing device plays back a signal over a loudspeaker, that loudspeaker can be an integrated component of the computing device or in wired or wireless communication with the computing device. In the case of a wired or wireless headset, a microphone and one or more loudspeakers can be integrated into a single peripheral device that sends microphone signals to a corresponding computing device and outputs a playback signal received from the computing device.

### Machine Learning Overview

There are various types of machine learning frameworks that can be trained to perform a given task, such as estimating the quality of a signal, enhancing a signal, aligning frames of a microphone signal, and/or generating embeddings representing vocal characteristics of speakers. Support vector machines, decision trees, and neural networks are just a few examples of machine learning frameworks that have been used in a wide variety of applications, such as image processing and natural language processing. Some machine learning frameworks, such as neural networks, use layers of nodes that perform specific operations.

In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs. Various training procedures can be applied to learn the edge weights and/or bias values. The term “internal parameters” is used herein to refer to learnable values such as edge weights and bias values that can be learned by training a machine learning model, such as a neural network. The term “hyperparameters” is used herein to refer to characteristics of model training, such as learning rate, batch size, number of training epochs, number of hidden layers, activation functions, etc.

A neural network structure can have different layers that perform different specific functions. For example, one or more layers of nodes can collectively perform a specific operation, such as pooling, encoding, or convolution operations. For the purposes of this document, the term “layer” refers to a group of nodes that share inputs and outputs, e.g., to or from external sources or other layers in the network. The term “operation” refers to a function that can be performed by one or more layers of nodes. The term “model structure” refers to an overall architecture of a layered model, including the number of layers, the connectivity of the layers, and the type of operations performed by individual layers. The term “neural network structure” refers to the model structure of a neural network. The term “trained model” and/or “tuned model” refers to a model structure together with internal parameters for the model structure that have been trained or tuned. Note that two trained models can share the same model structure and yet have different values for the internal parameters, e.g., if the two models are trained on different training data or if there are underlying stochastic processes in the training process.

### Example System

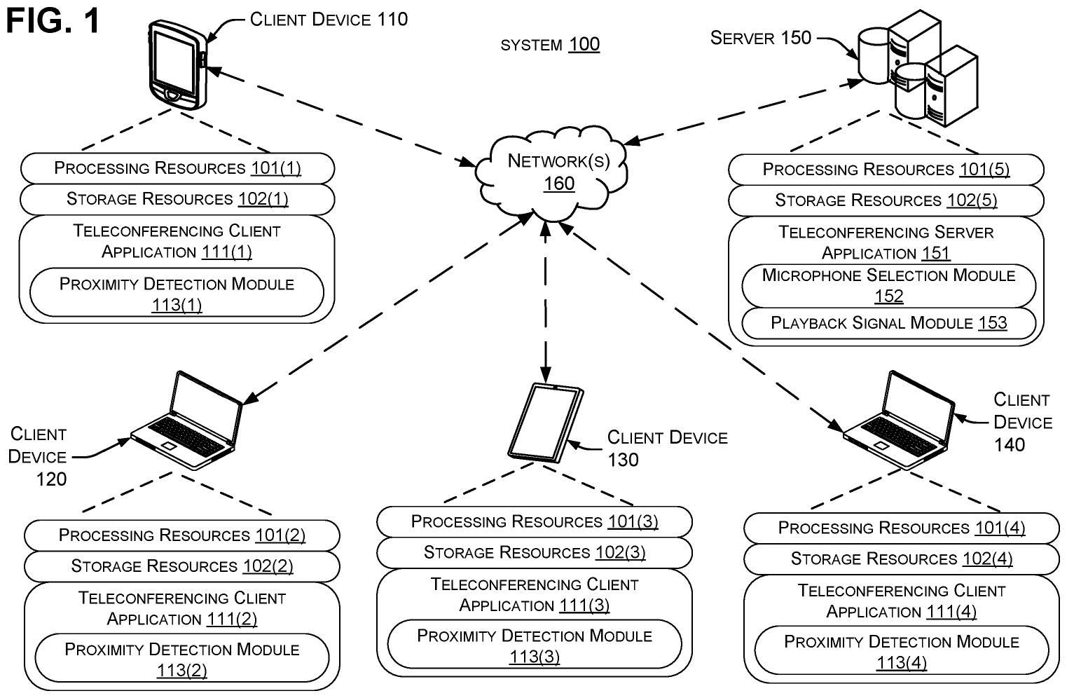

The present implementations can be performed in various scenarios on various devices. FIG. 1 shows an example system 100 in which the present implementations can be employed, as discussed more below.

As shown in FIG. 1, system 100 includes a client device 110, a client device 120, a client device 130, a client device 140, and a server 150, connected by one or more network(s) 160. Note that the client devices can be embodied as mobile devices such as smart phones, laptops, or tablets, as well as stationary devices such as desktops, server devices, etc. Likewise, the servers can be implemented using various types of computing devices. In some cases, any of the devices shown in FIG. 1, but particularly the servers, can be implemented in data centers, server farms, etc.

Certain components of the devices shown in FIG. 1 may be referred to herein by parenthetical reference numbers. For the purposes of the following description, the parenthetical (1) indicates an occurrence of a given component on client device 110, (2) indicates an occurrence of a given component on client device 120, (3) indicates an occurrence of a given component on client device 130, (4) indicates an occurrence of a given component on client device 140, and (5) indicates an occurrence on server 150. Unless identifying a specific instance of a given component, this document will refer generally to the components without the parenthetical.

Generally, the devices 110, 120, 130, 140, and/or 150 may have respective processing resources 101 and storage resources 102, which are discussed in more detail below. The devices may also have various modules that function using the processing and storage resources to perform the techniques discussed herein. The storage resources can include both persistent storage resources, such as magnetic or solid-state drives, and volatile storage, such as one or more random-access memory devices. In some cases, the modules are provided as executable instructions that are stored on persistent storage devices, loaded into the random-access memory devices, and read from the random-access memory by the processing resources for execution.

Client devices 110, 120, 130, and/or 140 can include respective instances of a teleconferencing client application 111. The teleconferencing client application can provide functionality for allowing users of the client devices to conduct audio teleconferencing with one another, with and/or without video functionality. Each instance of the teleconferencing client application can include a corresponding proximity detection module 113. The proximity detection module can be configured to detect when other client devices are in proximity. As discussed more below, the proximity detection module can employ various techniques to detect whether other devices are in proximity. In some cases, the proximity detection module can be configured to estimate whether other devices are in the same room. Thus, for instance, proximity detection module 113(1) on client device 110 can detect when client device 120 arrives in the same room as client device 110, e.g., based on a sound or radio frequency signal emitted by proximity detection module 113(2) on client device 120. Likewise, proximity detection module 113(1) can also detect when client device 120 leaves the room.

Teleconferencing server application 151 on server 150 can coordinate calls among the individual client devices by communicating with the respective instances of the teleconferencing client application 111 over network 160. For instance, teleconferencing server application 151 can have a microphone selection module 152 that can select different microphones to use at different times. As discussed more below, the microphone selection module can select microphones based on various sound quality metrics. The microphone selection module can also associate specific microphones with specific speakers based on their vocal characteristics, as described more below. Teleconferencing server application 151 can also have a playback signal module 153 that generates audio and/or video playback signals. For instance, the playback signal module can select, synchronize, and/or mix selected microphone signals from the respective client devices to obtain one or more playback signals, and communicate the playback signals to one or more remote client devices during a call. For video conferencing scenarios, the playback signal module can also mix video signals together with the audio signals and communicate the mixed video/audio signals to participants in a call. As discussed more below, microphone selection can be performed in an adaptive manner that mitigates certain impairments that would otherwise occur if all microphones in a given room were to contribute to a playback signal.

In some cases, the playback signal module 153 can perform proximity-based mixing. For instance, if any two client devices are not in proximity to one another, the playback signal module can send playback signals to these client devices that include microphone signals from the other device. In other words, each client device receives a playback signal that includes the microphone signal captured by the other device. Once the server determines that any two client devices are co-located, the playback signal module can adjust the audio mix by omitting the microphone signals from these two devices from the playback signals sent thereto. This is feasible because users in the same room should be able to hear each other speak without playback by the teleconferencing client application 111. Said another way, the playback signal delivered to a particular client device can be adjusted by the playback signal module to omit microphone signals from other client devices that are in proximity to that particular client device, as described more below.

### Single Speaker Call Scenarios

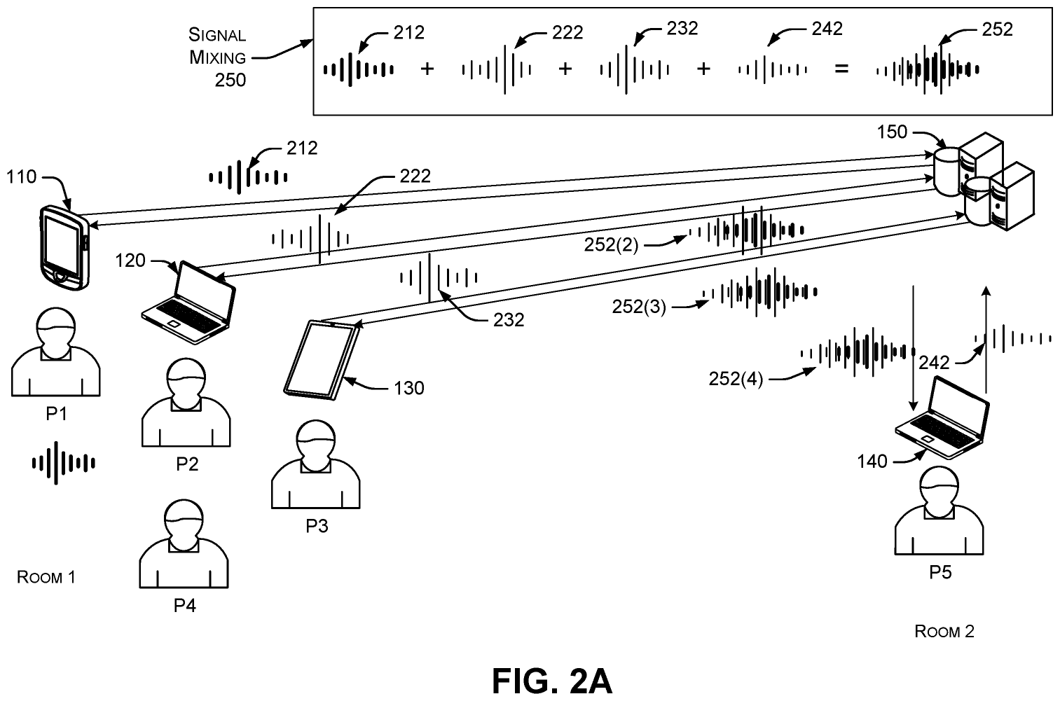

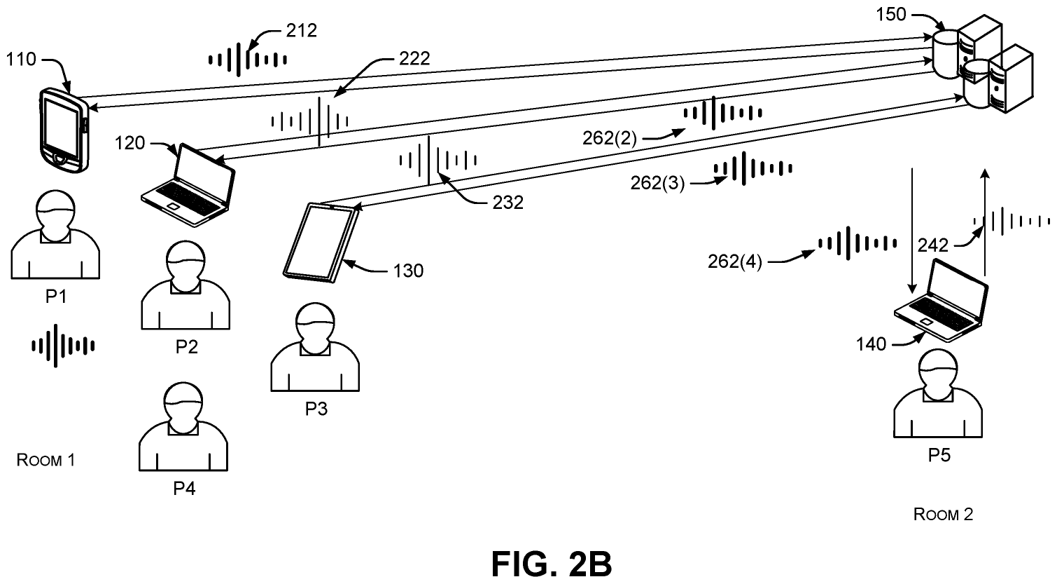

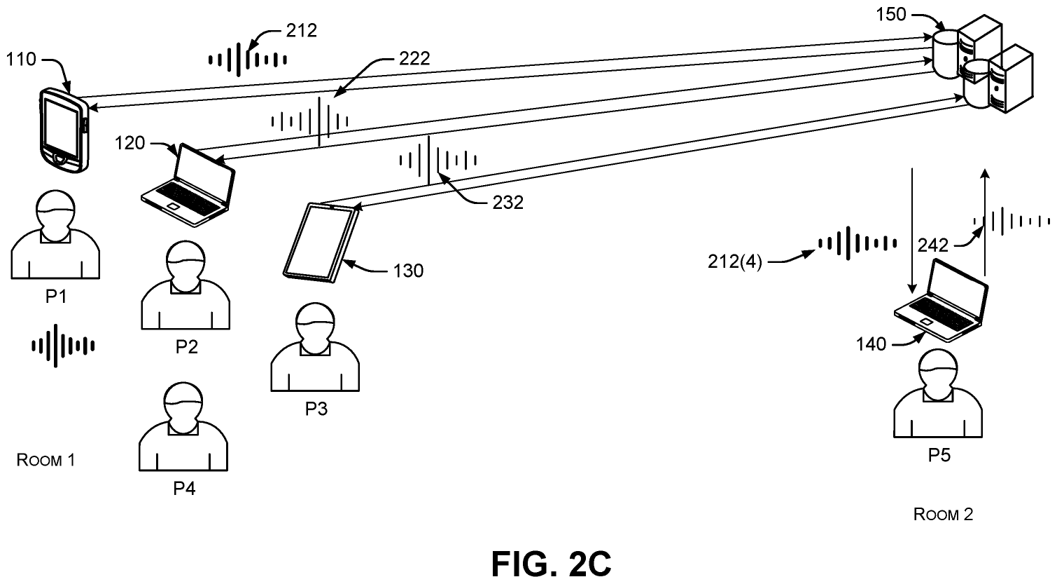

FIG. 2A-2C illustrate scenarios where one speaker (P1) in a room with several other speakers (P2, P3, and P4) speaks at a given time, while participating in a call with a remote user (P5). As described more below, capturing a single user's speech with multiple microphones can introduce impairments such as noise and reverberation that degrade call quality, and FIG. 2B shows how adaptive microphone selection can mitigate these impairments. In addition, replaying signals captured in the same room as the speaker can cause echoes, and FIG. 2C shows how proximity-based mixing can mitigate echoes.

FIG. 2A illustrates a scenario where the microphones of each of the respective client devices contribute to the playback signal and the server 150 does not perform proximity-based mixing. A first user P1 speaks into client device 110, and the microphone of client device 110 picks up microphone signal 212. Microphone signal 212 is sent to the server 150. In addition, client device 120 picks up the speech by first user P1 and communicates a microphone signal 222 to the server. Client device 130 picks up the speech by first user P1 and communicates a microphone signal 232 to the server. Client device 140 also picks up a microphone signal 242 from room 2 and communicates this to server 150. The server mixes the received microphone signals together as shown via signal mixing 250 to create a playback signal 252. The server communicates the playback signal to client devices 120, 130, and 140 as respective playback signals 252(2), 252(3), and 252(4) for playback on these client devices. Note that the server generally does not send a playback signal to the client device associated with a currently-active speaker, and thus no playback signal is illustrated as being sent from the server to client device 110.

Note that the microphone on client devices 120 and 130 pick up various sounds, including speech by the user P1 in the same room as client device 120 as well as any ambient noise in the room. The introduction of crosstalk picked up by client devices 120 and 130 when user P1 speaks can introduce undesirable artifacts that degrade call quality, such as noise and reverberation. Further, P1's speech being played back in the room and recaptured by client device 110 could form positive feedback to create howling.

FIG. 2B illustrates a scenario where the server adaptively selects a single microphone to produce the playback signal. Assume that the microphone on client device 110 captures a higher-quality signal than any of the other microphones, e.g., as determined by one or more microphone selection criteria such as signal-to-noise ratio or a speech quality metric provided by an automated model, as discussed more below. The server communicates playback signals 262(2), 262(3), and 262(4) to client devices 120, 130, and 140, respectively. Note that these playback signals are derived from microphone signal 212, but exclude microphone signals 222, 232, and 242.

While adaptive microphone selection can remove crosstalk-induced impairments within a given room as shown above, the playback signals 262(2) and 262(3) provided by the server to client devices 120 and 130, respectively can cause echoes and howling. This is because loudspeakers are playing back these playback signals in room 1 shortly after speech by user P1. In other words, P1's actual voice is heard first by users P1, P2, P3, and P4, followed by playback signals 262(2) and 262(3). These playback signals can feed back into microphone signal 212, resulting in an echo or howling because the playback signals include the voice of user P1.

FIG. 2C illustrates a single-speaker scenario where, in addition to adaptive microphone selection, the server automatically detects which devices are in the room with the speaker and performs proximity-based mixing to remove undesirable artifacts. For instance, responsive to detecting that client devices 110, 120, and 130 are co-located, server 150 can omit microphone signals picked up by client devices 120 and 130 from playback by these devices. Thus, users P2, P3, and P4 in Room 1 can simply hear the actual speech by user P1 without subsequent replay by the teleconferencing application, while remote user P5 hears speech by user P1 played back by client device 140.

### Multiple Speaker Call Scenarios

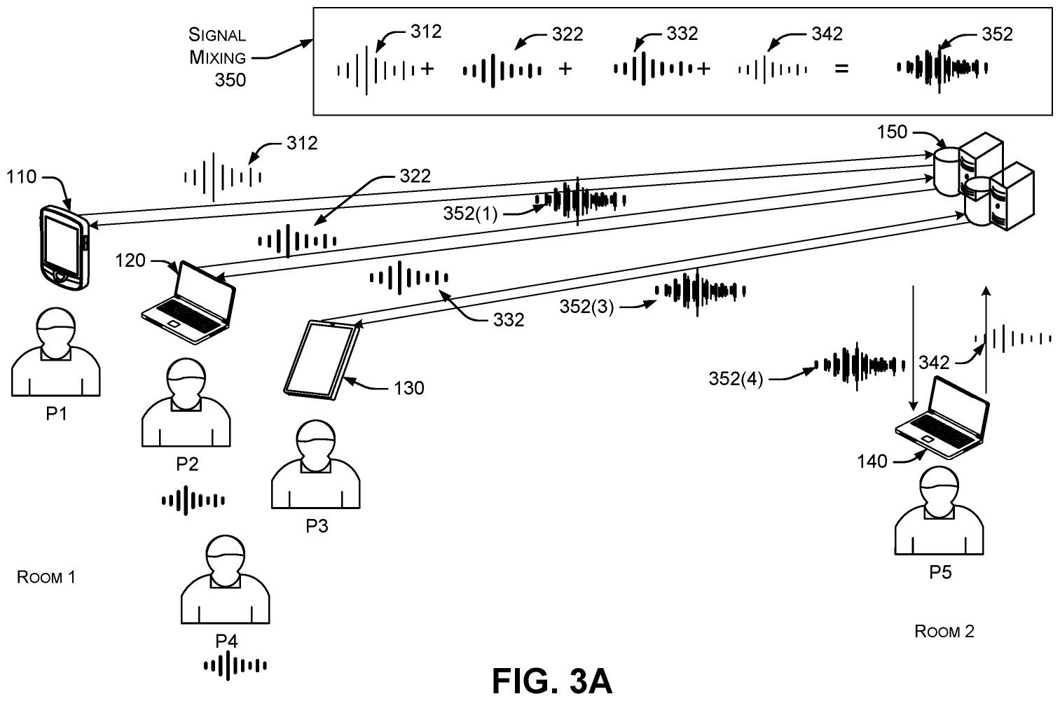

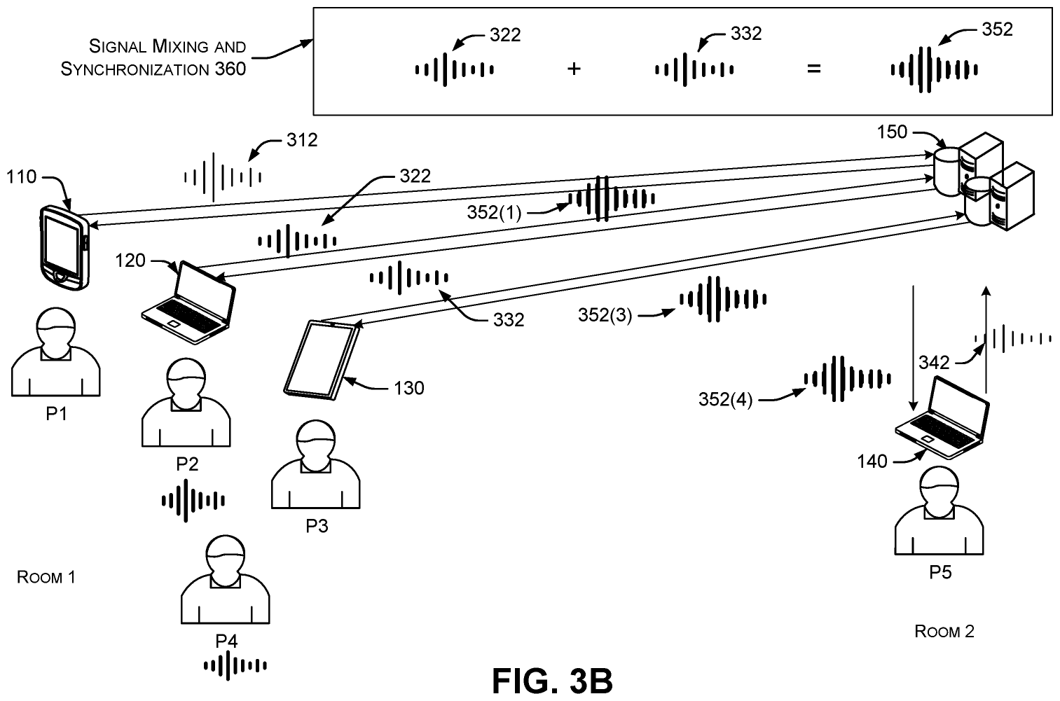

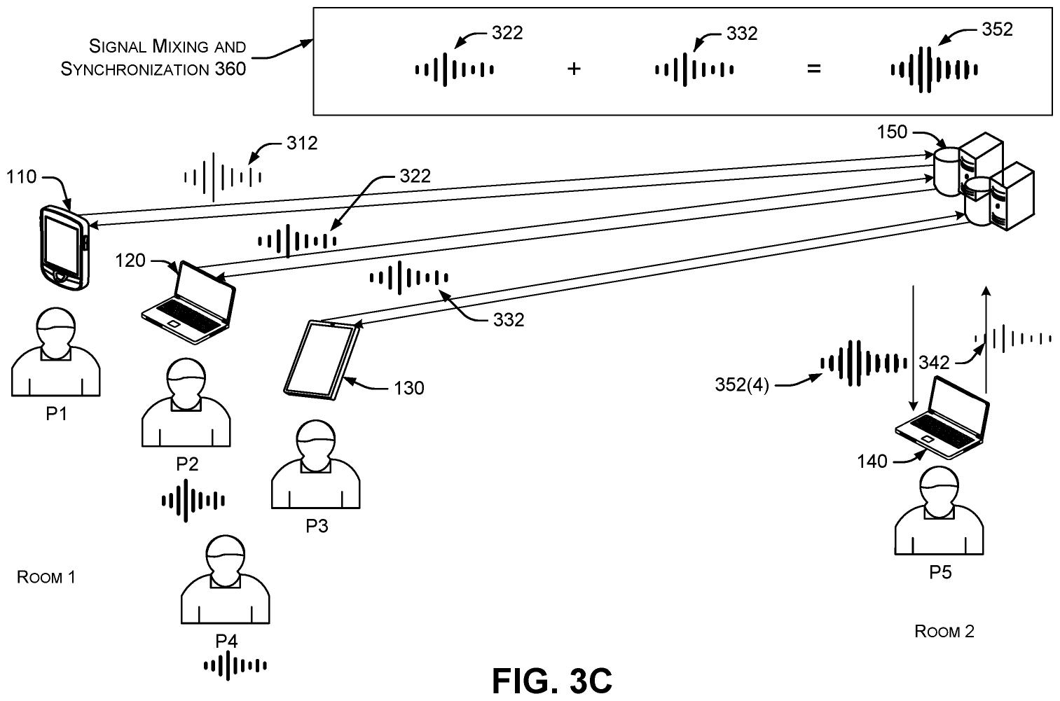

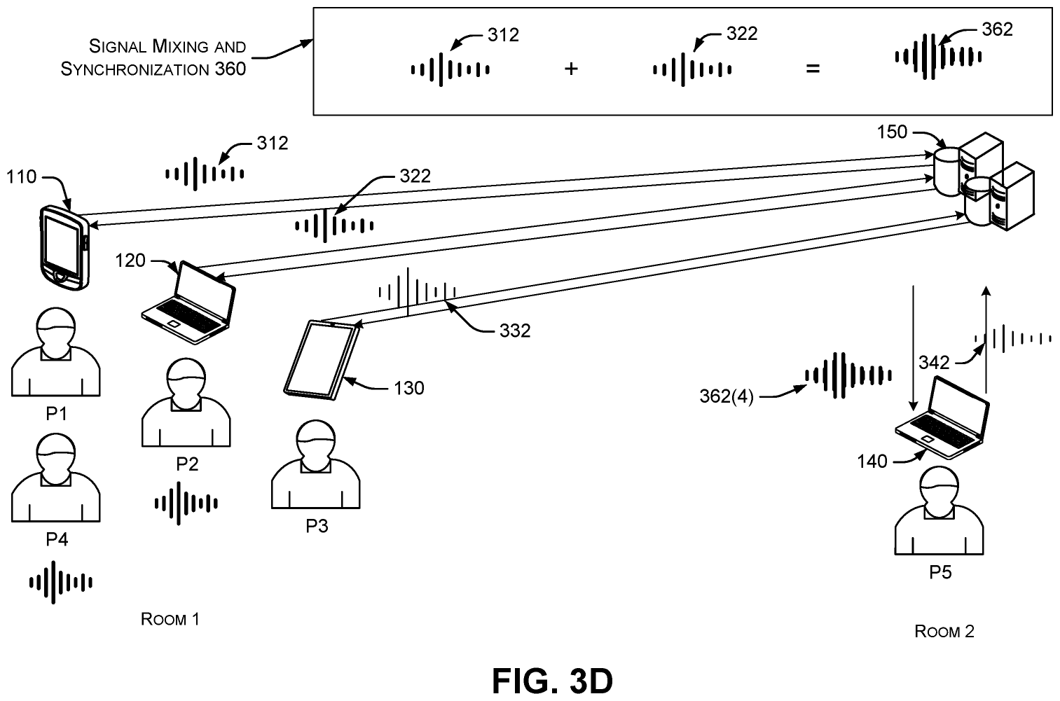

FIGS. 3A-3D extend the single-speaker scenario described above to include speech by multiple users, user P2 and P4. As described more below, capturing speech by users P2 and P4 with all co-located microphones as shown in FIG. 3A can introduce impairments that degrade call quality. On the other hand, using only a single microphone can also result in impairments that degrade call quality. FIG. 3B shows how adaptive microphone selection of multiple (but not all) co-located microphones can mitigate these impairments. In addition, as noted previously, replaying signals captured in the same room as the speaker can cause echoes, and FIG. 3C shows how proximity-based mixing can mitigate echoes. FIG. 3D shows how a different microphone can be selected for user P4 when user P4 moves within room 1.

FIG. 3A illustrates a scenario where the microphones of each of the respective client devices contribute to the playback signal and the server 150 does not perform proximity-based mixing. User P2 speaks into their client device 120, and user P4 speaks concurrently with user P2 but does not have an associated client device. The microphone of client device 110 picks up microphone signal 312, which includes speech by both P2 and P4. Microphone signal 312 is sent to the server 150. In addition, client device 120 picks up the speech by users P2 and P4 and communicates a microphone signal 222 to the server. Client device 130 picks up the speech by users P2 and P4 and communicates a microphone signal 232 to the server. Client device 140 also picks up a microphone signal 242 from room 2 and communicates this to server 150. The server mixes the received microphone signals together as shown via signal mixing 350 to create playback signal 352, which is communicated to client devices 110, 130, and 140 as respective playback signals 352(1), 352(3), and 352(4) for playback on these client devices. Again, the server generally does not send a playback signal to the client device associated with a currently-active speaker, and thus no playback signal is illustrated as being sent from the server to client device 120.

Note that the microphones on client devices 110 and 130 pick up various sounds, including speech by the users P2 and P4 in the same room as these devices as well as any ambient noise in the room. The introduction of crosstalk picked up by client devices 110 and 130 can introduce undesirable artifacts that degrade call quality, such as noise and reverberation. In addition, speech by users P2 and P4 being played back on client devices 110 and 130 can create undesirable echoes or howling that further degrade call quality unless these two client devices are synchronized to within approximately 40 ms or less.

FIG. 3B illustrates a scenario where the server adaptively selects multiple microphones to produce the playback signal. Assume that the microphones on client devices 120 and 130 capture higher-quality signal than the microphones on the other client devices, e.g., as determined by one or more microphone selection criteria such as signal-to-noise ratio or a speech quality metric provided by an automated model, as discussed more below. This is conveyed by the location of speaker P4 in FIG. 3B, as P4 is closer to client devices 120 and 130 and thus it is likely that the microphone on client device 110 will not have as high a quality as the microphones on client devices 120 and 130.

As shown in signal mixing and synchronization 360, the server synchronizes signals 322 and 332, received from client devices 120 and 130, respectively, and mixes them to produce playback signal 352. Note, however, that signals 312 and 342 originating from client devices 110 and 140, respectively, are excluded. The server communicates playback signals 352(1), 352(3), and 352(4) to client devices 110, 130, and 140, respectively.

While adaptive microphone selection can remove crosstalk-induced impairments within a given room as shown above, the playback signals 352(1) and 352(3) provided by the server to client devices 110 and 130, respectively, can cause echoes. This is because loudspeakers are playing back these playback signals in room 1 shortly after speech by users P2 and P4. In other words, the actual voices of P2 and P4 are heard first by users P1, P2, P3, and P4, followed by playback signals 352(1) and 352(3). These playback signals can feed back into microphone signals captured by the client devices in the room, resulting in an echo because the playback signals include the voices of users P2 and P4.

FIG. 3C illustrates a multiple-speaker scenario where, in addition to adaptive microphone selection, the server automatically detects which devices are in the room with the speaker and performs proximity-based mixing to remove undesirable artifacts. For instance, responsive to detecting that client devices 110, 120, and 130 are co-located, server 150 can omit microphone signals picked up by client devices 110 and 130 from playback by these devices. Thus, users P2, P3, and P4 in Room 1 can simply hear the actual speech by user P2 and P4 without subsequent replay by the teleconferencing application, while remote user P5 hears speech by users P2 and P4 played back by client device 140.

FIG. 3D illustrates a multiple-speaker scenario with both adaptive microphone selection and proximity-based mixing. In FIG. 3D, user P4 moves away from client device 130 and closer to client device 110. Thus, signal 312 from client device 110 likely will have higher signal quality than signal 332 from client device 130. As a consequence, microphones on client devices 110 and 120 are adaptively selected, and signals 312 and 322 obtained from those microphones are provided for signal mixing and synchronization 360 to obtain playback signal 362. Note that signal 332 obtained from client device 130 and signal 342 obtained from client device 140 are omitted from the playback signal. The playback signal is provided as 352(4) to client device 140 for playback in room 2.

### Example Teleconferencing Architecture

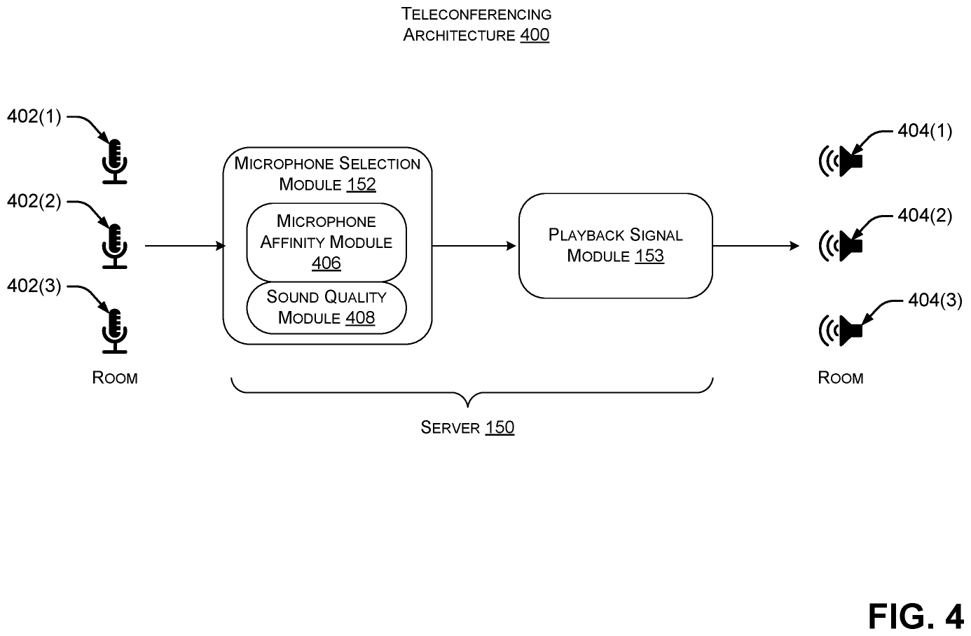

FIG. 4 illustrates a teleconferencing architecture 400 in which the disclosed implementations can be provided. The following describes functionality of individual components of the teleconferencing architecture, such as microphone selection module 152 and playback signal module 153, as implemented on server 150. However, these components can also be implemented locally on end-user devices, such as client devices 110, 120, 130 and/or 140. As described more below, signals from microphones 402(1), 402(2), and 402(3) on individual client devices can be processed using the teleconferencing architecture 400 for playback on loudspeakers 404(1), 404(2), and 404(3) of other client devices.

Vocal characteristics can be obtained from a user while the user participates in a call by microphone affinity module 406. The vocal characteristics could be, for example, the fundamental pitch of a given speaker, or a vector embedding representing acoustic characteristics of the user's speech. The microphone affinity module 406 can use vocal characteristics to associate individual speakers with respective microphones. As described more below, the microphone affinity module can select a particular microphone (or a weighted sum of multiple microphones) for a particular speaker that exhibits high sound quality as determined by sound quality module 408. To prevent rapid switching between microphones for a given speaker, the microphone affinity module can retain the association between a given microphone and speaker unless the signal quality for a given speaker is higher for another microphone by at least a threshold percentage for a threshold period of time. The sound quality module can provide sound quality characteristics such as reverberation, coloration, discontinuities, loudness, and overall speech quality for each microphone signal to the microphone affinity module, which the microphone affinity module can employ to select which microphone is associated with a given speaker. Signal-to-noise ratio can also be considered, e.g., an SNR>30 dB is ideal. However, note that another microphone further away from a given speaker may have a higher SNR, and thus the use of other sound quality characteristics can be useful for microphone selection.

Playback signal module 153 can synchronize the selected microphone signals prior to mixing, and can pe. In some cases, loudspeakers can also be synchronized with other speakers of other co-located devices. Various approaches can be employed for microphone and/or loudspeaker synchronization, including cross-correlation based approaches (e.g., searching on a lag parameter to maximize cross correlation and thus find the best synchronization of the signals), attention-based deep neural network approaches, and/or network time-based approaches, as described more below. The playback signal module can also implement digital gain control and sound/video encoding before sending a packetized playback signal to individual client devices for playback thereon.

### Proximity Discovery Mechanisms

As noted previously, the teleconferencing server application 151 on server 150 can perform proximity-sensitive mixing by adjusting how received microphone signals are mixed into a playback signal when two or more devices participating in a given call are co-located. Various approaches for identifying co-located devices are contemplated. For instance, in some cases, users can be provided with the ability to manually identify other users that are in the same room prior to conducting a given call, e.g., by a graphical user interface. As another example, in some cases, the server can access user data to determine the expected location of a given user at a given time, and can infer that two devices are co-located when the user data indicates that both users are at the same location.

In other cases, location information can be employed to automatically infer that two or more devices are co-located. For instance, in some cases, each client device can report its location to the server 150, as determined using local device sensors, such as Global Positioning System sensors, accelerometers, gyroscopes, or Wi-Fi based positioning. The server can then designate any devices within a specified distance threshold as co-located for the purposes of conducting a call. As yet another example, Wi-Fi or Bluetooth discovery mechanisms can be employed to estimate the distance between any two devices.

Generally speaking, any of the aforementioned techniques can be sufficient to determine the respective distance between two client devices. However, in some cases, two client devices may be relatively close to one another but not in the same room. Consider two users in adjacent office rooms separated by a wall that significantly attenuates sound travel between the two rooms. In this case, the users may not be able to hear one another's voice through the walls, and would prefer to have the playback signal module 142 send them their neighbor's microphone signal for playback.

Thus, in some cases, sound can be employed to determine whether two client devices should be treated as co-located for mixing purposes. For instance, client device 110 can play an audio clip at an ultrasound frequency at a designated volume, and client device 120 can listen for that sound. Based on the volume of sound received by client device 120, an inference can be made as to whether the two devices are sufficiently close to consider the devices as being co-located. Additional details on using ultrasound to discover nearby devices can be found in U.S. Pat. No. 9,742,780 and Borriello et al., “Walrus: Wireless Acoustic Location with Room-level Resolution using Ultrasound,” in Proceedings of the 3rd International Conference on Mobile Systems, Applications, and Services, Jun. 6, 2005 (pp. 191-203).

### Loudspeaker Synchronization

Another technique that can be employed to enhance audio quality involves loudspeaker synchronization. When two or more client devices arrive in the same room, they may play back audio received from a remote user at different times. For instance, each device may receive incoming packets at different times, and/or may have different hardware or software characteristics that impact playback timing. Thus, some implementations can involve loudspeaker synchronization for loudspeakers on each device, e.g., using a shared network clock or other mechanism to align playback.

In some cases, loudspeaker synchronization can be implemented using Network Time Protocol (NTP) to synchronize loudspeakers within 1 millisecond of each other. This can mitigate undesirable in-room perception of reverberation that could otherwise be caused by unsynchronized playback. In addition, a microphone co-located with multiple loudspeakers can capture playback signals from each loudspeaker. Subsequently, cross-correlation analysis or attention-based techniques can be used to align the different playback signals. In further cases, a network time service such as NTP can be employed to perform rough initial synchronization, which can be refined via microphone capture and cross-correlation or attention-based techniques.

### Example Method

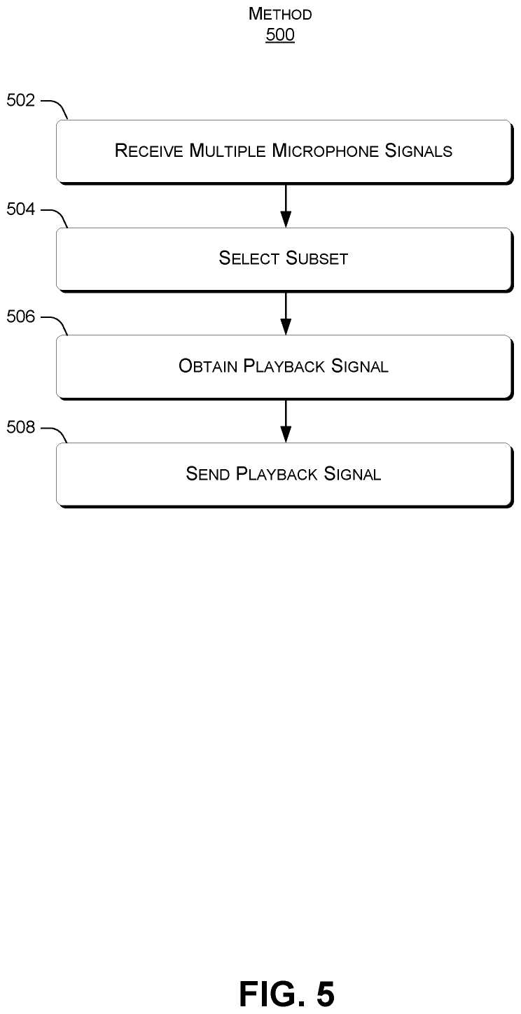

FIG. 5 illustrates an example method 500, consistent with some implementations of the present concepts. Method 500 can be implemented on many different types of devices, e.g., by one or more cloud servers, by a client device such as a laptop, tablet, or smartphone, or by combinations of one or more servers, client devices, etc.

Method 500 begins at block 502, where multiple microphone signals are received from multiple co-located devices (e.g., client devices 110, 120, and/or 130). As noted previously, co-located devices can be devices within the same room that participate in an audio call with one or more remote devices.

Method 500 continues at block 504, where a microphone subset is selected based on respective signal characteristics of the multiple microphone signals. As noted previously, the signal characteristics can include signal-to-noise ratios of the microphone signals, speech quality characteristics of the microphone signals as determined by a machine learning model, etc.

Method 500 continues at block 506, where a playback signal is obtained from one or more microphone signals output by the selected microphone subset. In cases where the selected microphone subset includes multiple microphones, the microphone signals can be synchronized and mixed to produce the playback signal.

Method 500 continues at block 508, where the playback signal is sent to a remote device. For instance, the remote device can be located in a different room, and the playback signal can be sent to the remote device over a network. In some cases, the playback signal can be sent to multiple remote devices, either co-located (e.g., together in a different room) or in different locations from one another.

In some cases, some or all of method 500 is performed by a remote server. In other cases, some or all of method 500 is performed by one of the co-located devices. For instance, the co-located devices can form a distributed peer-to-peer mesh and select a particular device to receive the microphone signals, select the microphones to include in the selected subset, and communicate the playback signal to the remote device. In addition, note that, in some cases, one or more of the co-located devices may have a local, personalized enhancement model that enhances the microphone signal prior to being received at block 502.

### Microphone Selection and Synchronization

As noted above, the disclosed implementations provide for adaptive selection of a subset of microphones on co-located devices, which can improve audio quality of calls. Generally speaking, the subset can be any number from 1 . . . . N, and N can be less than the total number of co-located microphones. In some cases, N is statically defined, e.g., does not change as the number of microphones and/or speakers in the room fluctuates.

Referring back to FIGS. 2A-2C, in some cases, N can be 1. Assuming that N is statically defined as 1, then one way to select which microphone to use is simply to pick the microphone with the highest sound (e.g., speech) quality at any given time. As noted previously, one way to evaluate the sound quality of a given signal is to use the signal-to-noise ratio, e.g., by tracking average noise over a moving time window of frames (approximately 1 to 10 seconds).

Another approach for evaluating the quality of a given microphone signal involves employing a trained machine learning model. Each of the following US Patent Applications describes approaches for training and employing machine learning models to estimate signal quality, and each of the following US patent applications are incorporated herein by reference in their entirety: U.S. patent application Ser. No. 17,062,308, filed Oct. 2, 2020 (Attorney Docket No. 408965-US-NP), U.S. patent application Ser. No. 17/503,140, filed Nov. 8, 2021 (Attorney Docket No. 410448-US-NP), and U.S. patent application Ser. No. 17/502,680, filed Oct. 15, 2021 (Attorney Docket No. 410452-US-NP). For instance, a trained machine learning model can estimate signal characteristics such as speech quality, background noise, and overall signal quality on a frame-by-frame basis for each microphone signal.

In some cases, however, more than one user is speaking. Generally, using a single microphone to pick up multiple speakers can degrade audio quality. Thus, in some cases, N can be statically defined as 2 or more. Since having three or more concurrent speakers tends to be uncommon, setting N to a static value of 2 can be useful. This is sufficient to capture two speakers with high audio quality, without introducing additional microphones that might degrade audio quality. When N is set to 2 or more, for each frame, the N microphones with the highest microphone selection criteria can be synchronized and mixed to produce a playback signal.

In further cases, N can vary depending on the number of concurrent speakers. For instance, the number of current speakers can be automatically detected, and N can be set to that number. In other cases, N can be set to the number of current speakers but with a predefined maximum, e.g., 2. In this case, 1 microphone is employed when a single person is speaking, and 2 microphones are employed when two or more people are speaking.

The approach described above generally will result in selecting microphone frames at any given time that provide high audio quality. However, if microphones are selected on a frame-by-frame basis, then in some cases the microphones will switch quickly, potentially as quickly as the frame rate (e.g., using 20-40 ms frames). Rapid switching of microphones can cause a choppy audio effect. Thus, some implementations can employ a microphone affinity technique to associate specific users with specific microphones, and then select the microphones to use at any given time based on which speakers are active. This has the effect of stabilizing the microphone used to record a particular speaker over a period of time, to avoid rapid switching of microphones.

One scenario that can cause the microphone with the highest quality for a given speaker to fluctuate involves movement of the speaker and the microphone relative to one another. Referring back to FIG. 3D, P4 moved away from client device 130 and closer to client device 110. If the microphone selection module 152 initially selects the microphone on client device 130 for user P4, at some point the microphone selection module can switch to the microphone on client device 110. To avoid switching too rapidly, some implementations can employ a technique where signal quality and/or temporal thresholds are employed. As a simple example, some implementations can wait to switch microphones for a given user until another microphone exceeds the speech quality or signal-to-noise ratio for the current microphone by at least an average of 10% over a window of 1 second.

As noted previously, the microphone selection module 152 can utilize vocal characteristics of a user to determine which user is speaking at any given time. One approach involves estimating the fundamental pitch of each user. Another approach involves deriving embeddings for each user, where the embeddings represent the vocal characteristics. U.S. patent application Ser. No. 17/848,674, filed Jun. 24, 2022 (Attorney Docket No. 411559-US-NP), describes approaches for generating embeddings representing acoustic characteristics of speech by users, and is incorporated herein by reference in its entirety.

In some cases, users can perform explicit enrollment steps by speaking words into a microphone prior to participating in a given call, so that the user's vocal characteristics are known prior to the start of the call. In other cases, passive enrollment can be performed, by learning the user's vocal characteristics as they participate in a call.

As another point, a vector embedding representing speech characteristics of a given user can be considered a form of personally identifiable information that should be protected. For instance, a malicious actor could employ such an embedding to access a user's bank account by emulating their speech signature. Thus, in some implementations, various actions can be taken to protect the embedding. One implementation involves deriving the embedding entirely on the client device. In this case, the client device does not send the embedding or representation thereof over network 160. The client device can also protect the embedding by mechanisms such as local encryption.

Microphone selection based on signal quality can be performed using a heuristic, rules-based approach. For instance, individual microphone signals can be ranked based on scores computed using quality metrics such as reverberation, coloration, discontinuities, loudness, and overall speech quality. In some cases, the quality metrics can be weighted to determine weighted scores. To limit rapid microphone switching for a given speaker, a discounting approach can be implemented that discounts scores for non-selected microphones, thus discouraging switching microphones when the same person continues speaking.

In other implementations, a machine learning model can be employed to select the subset of microphones that is employed. For instance, a neural network could be trained to select a subset of microphones using training data having playback signals generated from different combinations of microphones for a given call. The playback signals could be manually labeled for audio signal characteristics such as reverberation, coloration, discontinuities, loudness, and overall speech quality, or automated quality estimation models could be employed to derive labels for the playback signals. During training, the microphone selection model could be encouraged to select microphone subsets that result in high scores for these characteristics of the playback signal. Note that, in some implementations, all microphones can be selected (even when only a single user is speaking) and a weighed sum of the microphone signals can be generated to provide high audio quality. The microphone selection model can be trained (e.g., using regression techniques) to determine respective weights of each selected microphone signal.

Once the microphones to be employed for the playback signal have been selected, their respective microphone signals can be synchronized. Some implementations employ network time protocol or classical cross-correlation analysis. Other implementations employ a deep neural network with an attention layer. U.S. patent application Ser. No. 17/743,754, filed May 13, 2022 (Attorney Docket No. 411294-US-NP), describes approaches for aligning signals using an attention layer, and is incorporated herein by reference in its entirety. In addition, some implementations can involve processing individual microphone signals differently, e.g., by applying different gains or phase shifts to the respective microphone signals. In some cases, different gains are applied to respective microphone signals in their entirety, and in other cases, spectrum normalization is performed by applying different frequency-specific gains to individual frequencies or frequency bands of a given microphone signal. The use of different frequency-specific gains can address scenarios where different microphones have different frequency response characteristics, so that the resulting playback signal exhibits high speech quality.

### Technical Effect

As noted previously, prior techniques for distributed teleconferencing tended to provide poor call quality in certain circumstances. For instance, users in the same room generally experienced poor audio quality when using their personal devices to participate in a given teleconference, because of echoes and other impairments. While alternatives such as hardwiring co-located devices together can allow for very tight synchronization and improved call quality, these approaches are inconvenient for most use cases.

Other alternatives, such as the use of personalized models to enhance microphone signals, can provide very high-quality audio. However, it is relatively burdensome to obtain personalized enhancement models for every participant in a call. For instance, in some cases, users perform explicit enrollment steps by speaking into a microphone so that a personalized enhancement model can be generated for that user. As a consequence, low user adoption rates can mean that, in many cases, at least some co-located devices will not have an available personalized enhancement model for the owner of that device. In addition, in some cases, participants in the call may not even use their own device, e.g., note that P4 does not have their own device in the examples discussed above.

In contrast to prior approaches, the disclosed techniques allow for ad-hoc teleconferencing sessions where co-located users can employ their own devices and still achieve high audio quality without burdensome steps such as physically connecting their devices and without necessarily having available personalized enhancement models. By adaptively selecting which co-located microphones contribute to a playback signal, audio quality can be improved for a range of criteria, including coloration, discontinuity, loudness, noise, reverberation, speech signal quality, and overall audio quality.

Furthermore, by employing microphone affinity techniques when multiple speakers are speaking, the disclosed techniques can avoid rapid switching between microphones for a particular speaker. This can avoid choppy signal quality that would otherwise occur. In addition, this allows for smooth transitions from one microphone to another if a user moves across a room closer to another microphone.

In addition, the disclosed techniques can employ proximity-based mixing that can adjust how microphone signals are mixed into playback signals depending on whether devices are co-located. For instance, microphone signals received from devices in a particular room can be omitted from playback signals transmitted to other devices in the same room. If a particular user leaves the room and their device is no longer co-located with the other devices in the room, then the mixing can be adjusted so that the playback signal sent to that user's device incorporates microphone signals from the other devices remaining in the room. As a consequence, users can seamlessly transition in and out of a given room while maintaining a high-quality audio experience.

### Device Implementations

As noted above with respect to FIG. 1, system 100 includes several devices, including a client device 110, a client device 120, a client device 130, a client device 140, and a server 150. As also noted, not all device implementations can be illustrated, and other device implementations should be apparent to the skilled artisan from the description above and below.

The term “device”, “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute computer-readable instructions to provide functionality. Computer-readable instructions and/or data can be stored on storage, such as storage/memory and or the datastore. The term “system” as used herein can refer to a single device, multiple devices, etc.

Storage resources can be internal or external to the respective devices with which they are associated. The storage resources can include any one or more of volatile or non-volatile memory, hard drives, flash storage devices, and/or optical storage devices (e.g., CDs, DVDs, etc.), among others. As used herein, the term “computer-readable media” can include signals. In contrast, the term “computer-readable storage media” excludes signals. Computer-readable storage media includes “computer-readable storage devices.” Examples of computer-readable storage devices include volatile storage media, such as RAM, and non-volatile storage media, such as hard drives, optical discs, and flash memory, among others.

In some cases, the devices are configured with a general purpose hardware processor and storage resources. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.), microphones, etc. Devices can also have various output mechanisms such as printers, monitors, speakers, etc.

Also note that the devices described herein can function in a stand-alone or cooperative manner to implement the described techniques. For example, the methods and functionality described herein can be performed on a single computing device and/or distributed across multiple computing devices that communicate over network(s) 160. Without limitation, network(s) 160 can include one or more local area networks (LANs), wide area networks (WANs), the Internet, and the like.

### ADDITIONAL EXAMPLES

Various examples are described above. Additional examples are described below. One example includes a method comprising receiving multiple microphone signals from multiple co-located devices having respective microphones, selecting a microphone subset from the respective microphones based at least on respective signal characteristics of the multiple microphone signals, obtaining a playback signal from one or more microphone signals output by the selected microphone subset, and sending the playback signal to a remote device that is participating in a call with the multiple co-located devices.

Another example can include any of the above and/or below examples where the respective signal characteristics comprise signal-to-noise ratios of the multiple microphone signals.

Another example can include any of the above and/or below examples where the respective signal characteristics comprise speech quality characteristics of the multiple microphone signals.

Another example can include any of the above and/or below examples where the method further comprises detecting that multiple speakers are speaking, responsive to detecting that the multiple speakers are speaking, selecting multiple microphones to capture the multiple speakers and include in the selected microphone subset based at least on the respective signal characteristics, and synchronizing and mixing multiple microphone signals received from the multiple selected microphones to obtain the playback signal.

Another example can include any of the above and/or below examples where the synchronizing is based at least on a network time service.

Another example can include any of the above and/or below examples where the synchronizing is based on cross-correlation analysis of the multiple microphone signals received from the multiple selected microphones.

Another example can include any of the above and/or below examples where the synchronizing is performed by inputting the multiple microphone signals received from the multiple selected microphones into a deep neural network having an attention layer.

Another example can include any of the above and/or below examples where the method further comprises associating a particular microphone with a particular speaker based at least on a particular signal characteristic of a particular microphone signal received from the particular microphone.

Another example can include any of the above and/or below examples where the method further comprises determining a particular vocal characteristic of the particular speaker, detecting that the particular speaker is speaking based at least on the particular vocal characteristic, and when the particular speaker is speaking, selecting the particular microphone to include in the selected microphone subset.

Another example can include any of the above and/or below examples where the particular vocal characteristic is a fundamental pitch of the particular speaker.

Another example can include any of the above and/or below examples where the particular vocal characteristic is represented as an embedding.

Another example can include any of the above and/or below examples where the method further comprises determining that another microphone signal received from another microphone has relatively higher signal quality than the particular microphone signal and in response, associating the another microphone with the particular speaker.

Another example can include any of the above and/or below examples where the another microphone is associated with the particular speaker when signal quality of the another microphone signal exceeds signal quality of the particular microphone signal by at least a threshold amount for at least a threshold period of time.

Another example can include any of the above and/or below examples where the mixing comprises applying different gains to entire individual microphone signals or applying frequency-specific gains to the individual microphone signals.

Another example can include any of the above and/or below examples where the method further comprises applying an enhancement model to at least one microphone signal from the selected microphone subset.

Another example can include a system comprises a processor and a storage medium storing instructions which, when executed by the processor, cause the system to receive multiple microphone signals from multiple co-located devices having respective microphones, select a microphone subset from the respective microphones based at least on respective signal characteristics of the multiple microphone signals, obtain a playback signal from one or more microphone signals output by the selected microphone subset, and send the playback signal to a remote device that is participating in a call with the multiple co-located devices.

Another example can include any of the above and/or below examples where the server is embodied on a server device remotely from the multiple co-located devices.

Another example can include any of the above and/or below examples where the server is embodied on a particular one of the co-located devices.

Another example can include any of the above and/or below examples where the instructions, when executed by the processor, cause the system to form a peer-to-peer mesh with other co-located devices and communicate the playback signal to the other co-located devices in the peer-to-peer mesh.

Another example includes a computer-readable storage medium storing executable instructions which, when executed by a processor, cause the processor to perform acts comprising receiving multiple microphone signals from multiple co-located devices having respective microphones, selecting a microphone subset comprising two or more of the respective microphones based at least on respective signal characteristics of the multiple microphone signals, producing a playback signal by synchronizing and mixing two more microphone signals output by the two or more respective microphones of the selected microphone subset, and sending the playback signal to a third device that is participating in a call with the multiple co-located devices.

Another example can include any of the above and/or below examples where the acts further comprise selecting the microphone subset with a machine learning model having been trained using playback signals having audio quality labels.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A method comprising:
receiving multiple microphone signals from multiple co-located devices having respective microphones;
selecting a microphone subset from the respective microphones based at least on respective signal characteristics of the multiple microphone signals;
obtaining a playback signal from one or more microphone signals output by the selected microphone subset; and
sending the playback signal to a remote device that is participating in a call with the multiple co-located devices.

2. The method of claim 1, wherein the respective signal characteristics comprise signal-to-noise ratios of the multiple microphone signals.

3. The method of claim 1, wherein the respective signal characteristics comprise speech quality characteristics of the multiple microphone signals.

4. The method of claim 1, further comprising:
detecting that multiple speakers are speaking;
responsive to detecting that the multiple speakers are speaking, selecting multiple microphones to capture the multiple speakers and include in the selected microphone subset based at least on the respective signal characteristics; and
synchronizing and mixing multiple microphone signals received from the multiple selected microphones to obtain the playback signal.

5. The method of claim 4, wherein the synchronizing is based at least on a network time service.

6. The method of claim 4, wherein the synchronizing is based on cross-correlation analysis of the multiple microphone signals received from the multiple selected microphones.

7. The method of claim 4, wherein the synchronizing is performed by inputting the multiple microphone signals received from the multiple selected microphones into a deep neural network having an attention layer.

8. The method of claim 4, further comprising associating a particular microphone with a particular speaker based at least on a particular signal characteristic of a particular microphone signal received from the particular microphone.

9. The method of claim 8, further comprising:
determining a particular vocal characteristic of the particular speaker;
detecting that the particular speaker is speaking based at least on the particular vocal characteristic; and
when the particular speaker is speaking, selecting the particular microphone to include in the selected microphone subset.

10. The method of claim 9, the particular vocal characteristic being a fundamental pitch of the particular speaker.

11. The method of claim 9, the particular vocal characteristic represented as an embedding.

12. The method of claim 9, further comprising:
determining that another microphone signal received from another microphone has relatively higher signal quality than the particular microphone signal; and
in response, associating the another microphone with the particular speaker.

13. The method of claim 12, wherein the another microphone is associated with the particular speaker when signal quality of the another microphone signal exceeds signal quality of the particular microphone signal by at least a threshold amount for at least a threshold period of time.

14. The method of claim 4, wherein the mixing comprises applying different gains to entire individual microphone signals or applying frequency-specific gains to the individual microphone signals.

15. The method of claim 4, further comprising applying an enhancement model to at least one microphone signal from the selected microphone subset.

16. A system comprising:
a processor; and
a storage medium storing instructions which, when executed by the processor, cause the system to:
receive multiple microphone signals from multiple co-located devices having respective microphones;
select a microphone subset from the respective microphones based at least on respective signal characteristics of the multiple microphone signals;
obtain a playback signal from one or more microphone signals output by the selected microphone subset; and
send the playback signal to a remote device that is participating in a call with the multiple co-located devices.

17. The system of claim 16, embodied on a server device remotely from the multiple co-located devices.

18. The system of claim 16, embodied on a particular one of the co-located devices.

19. The system of claim 18, wherein the instructions, when executed by the processor, cause the system to:
form a peer-to-peer mesh with other co-located devices; and
communicate the playback signal to the other co-located devices in the peer-to-peer mesh.

20. A computer-readable storage medium storing executable instructions which, when executed by a processor, cause the processor to perform acts comprising:
receiving multiple microphone signals from multiple co-located devices having respective microphones;
selecting a microphone subset comprising two or more of the respective microphones based at least on respective signal characteristics of the multiple microphone signals;
producing a playback signal by synchronizing and mixing two more microphone signals output by the two or more respective microphones of the selected microphone subset; and
sending the playback signal to a third device that is participating in a call with the multiple co-located devices.

21. The computer-readable storage medium of claim 20, the acts further comprising:
selecting the microphone subset with a machine learning model having been trained using playback signals having audio quality labels.
